(19) United States
(12) Patent Application Publication
(10) Pub. No.: US 2020/0092519 A1
(43) Pub. Date: Mar. 19, 2020

(54) VIDEO CONFERENCE SYSTEM USING ARTIFICIAL INTELLIGENCE

(71) Applicant: LG ELECTRONICS INC., Seoul (KR)

(72) Inventors: Wonho SHIN, Seoul (KR); Jichan MAENG, Seoul (KR)

(73) Assignee: LG ELECTRONICS INC., Seoul (KR)

(21) Appl. No.: 16/691,018

(22) Filed: Nov. 21, 2019

(30) Foreign Application Priority Data
Jul. 25, 2019 (KR) 10-2019-0089946

(51) Int. Cl. H04N 7/15; G06N 3/08; G06F 3/16; G10L 17/00

(52) U.S. Cl. CPC H04N 7/152; G10L 17/005; G06F 3/167; G06N 3/08

(57) ABSTRACT

Disclosed is an artificial intelligence video conference system. The artificial intelligence video conference system learns content of speech of a speaker and a displayed screen using an artificial intelligence during video conference and performs various functions required for the video conference or search various information related to the video conference, thereby conducting the video conference more smoothly. At least one device of the artificial intelligence video conference system of the present disclosure may be associated with an artificial intelligence module, a robot, an augmented reality (AR) device, a virtual reality (VR) device, a device related to a 5G service, and the like.

### CROSS-REFERENCE TO RELATED APPLICATIONS

This application claims the priority benefit of Korean Patent Application No. 10-2019-0089946 filed on Jul. 25, 2019, which is incorporated herein by reference for all purposes as if fully set forth herein.

### BACKGROUND OF THE INVENTION

### Field of the Invention

The present disclosure relates to a video conference system using an artificial intelligence, and more particular, to a video conference system using an artificial intelligence that learns content of video conference during the video conference and performs a function required for the video conference in response to a command voice or searches various information related to the video conference to support the video conference to be smoothly progressed.

### Related Art

An interactive artificial intelligence is a program aimed at simulating conversations with humans via voice or text. Such interactive artificial intelligences are classified into a Q&A system, an intelligent search, a conversation companion, a personal assistant, and the like based on an intelligence acquisition scheme and information exchange scheme. Commercially available interactive artificial intelligence focuses on detecting specific words or phrases on an input and outputting prepared responses. Most commonly used personal assistant-type artificial intelligence has recently been built into smartphones often as a standard feature. Current personal assistant-type artificial intelligence is mostly based on a character set by a manufacturer.

In this connection, the interactive artificial intelligence was developed in a manner to allow a virtual character to communicate with a user in a virtual space, and to automatically select a conversation partner suitable for the user and connect the conversation partner with the user. For example, a configuration of conducting a conversation in a video conference manner in real time among a plurality of users includes an interactive agent. A conventional interactive agent was not be able to handle continuous conversations because the conventional interactive agent takes a manner of learning and processing a sentence as a basic unit. Further, the conventional interactive agent was not be able to answer questions that are not defined in advance because the conventional interactive agent proceeds focusing on performing defined functions rather than understanding a conversation situation.

### SUMMARY OF THE INVENTION

The present disclosure aims to solve the aforementioned needs and/or problems.

Further, a video conference system using an artificial intelligence of the present disclosure aims to learn content of video conference during the video conference and perform a function required for the video conference in response to a command voice or search various information related to the video conference to support the video conference to be smoothly progressed.

In an aspect, a video conference system using an artificial intelligence is provided. The video conference system includes: a conference-assisting device that learns content of conversation between a first user group and a second user group in tele-conference with the first user group, recognizes a preset wake up voice in the learned conversation content, detects a command voice of the first user group after the recognized wake up voice, recognizes the command voice and analyze an intent of the command voice, and executes an application program corresponding to the command voice or respond to the command voice, and a display device that displays the first user group and the second user group, and displays the application program executed by the conference-assisting device and corresponding to the command voice or display the response.

In one implement, the conference-assisting device may include a communication unit configured to transmit the command voice to the display device or to transmit the application program or the response corresponding to the instruction, and a processor that learns the content of the conversation between the first user group and the second user group, recognizes the preset wake up voice in the learned conversation content, detects the command voice of the first user group after the recognized wake up voice, recognizes the command voice and analyze the intent of the command voice, and executes the application program corresponding to the command voice or perform the response to the command voice.

In one implement, the conference-assisting device may further include a camera, wherein the camera captures an image of the first user group in tele-conference with the second user group under control of the processor, and provides the image of the first user group captured by the camera.

In one implement, the display device may divide a displayed main screen into first to third divided screens, display the image of the first user group on the first divided screen, display an image of the second user group on the second divided screen, and display the application program or the response corresponding to the recognition of the command voice of the first user group and the intent of the command voice on the third divided screen.

In one implement, the display device may further divide the main screen into a fourth divided screen, and convert the content of the conversation between the first user group and the second user group into text and display the converted text.

In one implement, the processor may acquire the command voice via the communication unit, apply information related to a situation in which the command voice is recognized to an artificial neural network (ANN) classifier, recognize the command voice of the first user group and analyze the intent of the command voice based on the application result, and execute the application program or respond corresponding to the recognition of the command voice of the first user group and the intent of the command voice based on the analysis result.

In one implement, the camera may capture a user who uttered the wake up voice among the first user group under control of the processor.

In one implement, the artificial neural network (ANN) classifier may be stored in an external artificial intelligence (AI) device, wherein the processor may transmit feature values related to the information related to the situation in which the command voice is recognized to the AI device, and obtain, from the AI device, the result of applying the information related to the situation in which the command voice is recognized to the artificial neural network (ANN) classifier.

In one implement, the artificial neural network (ANN) classifier may be stored in a network, wherein the processor may transmit the information related to the situation in which the command voice is recognized to the network, and obtain, from the network, the result of applying the information related to the situation in which the command voice is recognized to the artificial neural network (ANN) classifier.

In one implement, the processor may receive, from the network, downlink control information (DCI) used to schedule transmission of the information related to the situation in which the command voice is recognized, and wherein the information related to the situation in which the command voice is recognized may be obtained from the network based on the DCI.

In one implement, the processor may perform an initial access procedure to the network based on a synchronization signal block (SSB), wherein the information related to the situation in which the command voice may be recognized is transmitted to the network through a physical uplink shared channel (PUSCH), and wherein a demodulation-reference signal (DM-RS) of the SSB and the PUSCH may be QCLed (quasi co-located) for a QCL type D.

In one implement, the processor may control the communication unit to transmit the information related to the situation in which the command voice is recognized to an AI processor included in the network, and control the communication unit to receive AI processed information from the AI processor, wherein the AI processed information may be information obtained by recognizing the command voice of the first group and analyzing the intent of the command voice.

### BRIEF DESCRIPTION OF THE DRAWINGS

FIG. 1 illustrates a block diagram of a wireless communication system to which methods proposed herein may be applied.

FIG. 2 illustrates an example of a signal transmission/reception method in a wireless communication system.

FIG. 3 illustrates an example of basic operations of a user terminal and a 5G network in a 5G communication system.

FIG. 4 illustrates a video conference system using an artificial intelligence according to an embodiment of the present disclosure.

FIG. 5 is a block diagram of an intelligent conference-assisting device according to an embodiment of the present disclosure.

FIG. 6 is a diagram illustrating a server to which an intelligent conference-assisting device and a first intelligent conference-assisting device according to an embodiment are linked.

FIG. 7 illustrates a schematic block diagram of an intelligent conference-assisting device and a server in a video conference system using an artificial intelligence according to an embodiment of the present disclosure.

FIG. 8 illustrates a schematic block diagram of an intelligent conference-assisting device and a server according to another embodiment of the present disclosure.

FIG. 9 illustrates a schematic block diagram of an artificial intelligent agent that may implement speech synthesis according to an embodiment of the present disclosure.

FIG. 10 illustrates a schematic block diagram of an intelligent conference-assisting device according to another embodiment of the present disclosure.

FIG. 11 illustrates a video conference system using an artificial intelligence installed in a conference room according to an embodiment of the present disclosure.

FIG. 12 is a diagram for briefly describing a method for implementing a video conference system using an artificial intelligence according to an embodiment of the present disclosure.

FIG. 13 is a diagram for illustrating an example of determining a command voice state in an embodiment of the present disclosure.

FIG. 14 is a diagram for illustrating training through a data training unit, according to an embodiment of the present disclosure.

FIGS. 15 to 18 are diagrams for illustrating various examples displayed during a video conference according to an embodiment of the present disclosure.

The accompanying drawings included as a part of the detailed description to assist in understanding the present disclosure provide embodiments of the present disclosure and describe technical features of the present disclosure together with the detailed description.

### DETAILED DESCRIPTION OF THE EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

### A. Example of Block Diagram of UE and 5G Network

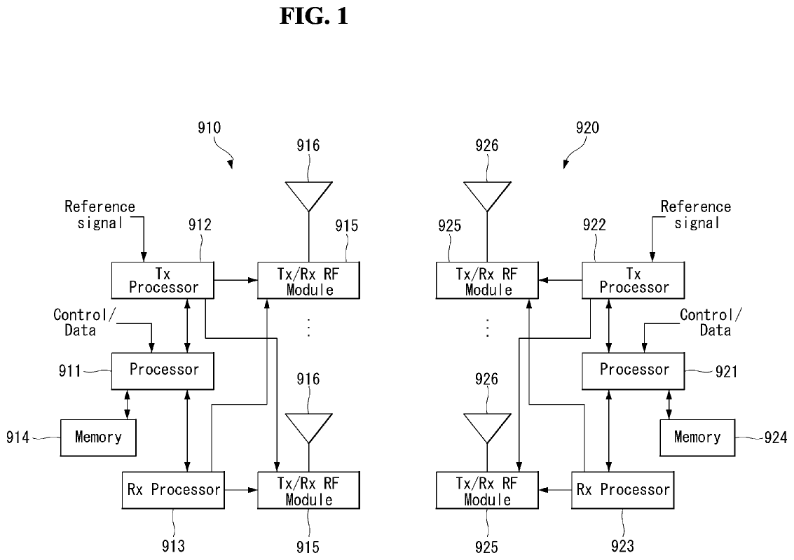

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

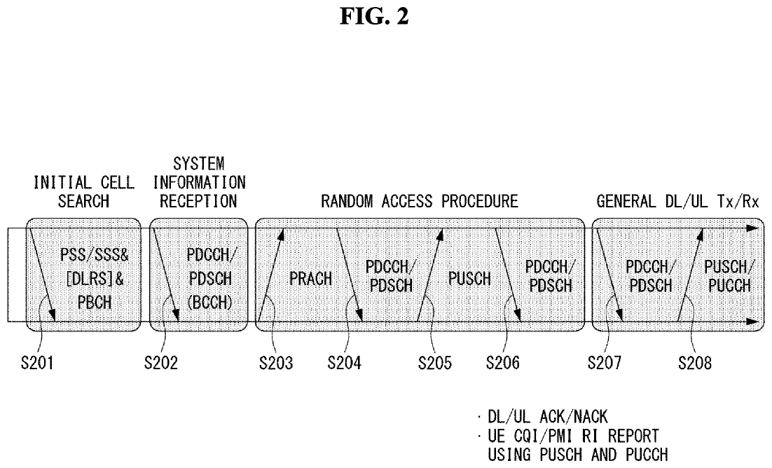

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequency Sect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. Basic Operation Between Autonomous Vehicles Using 5G Communication

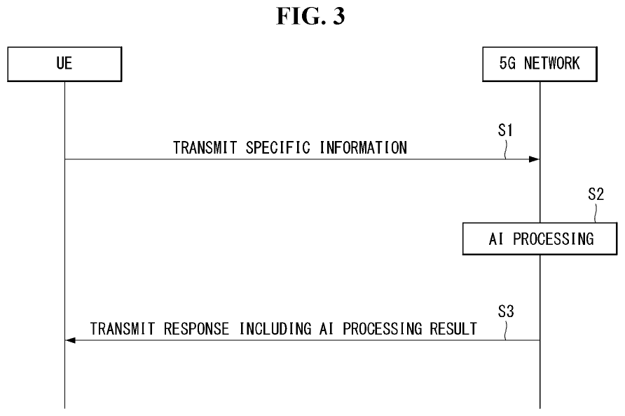

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

### G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

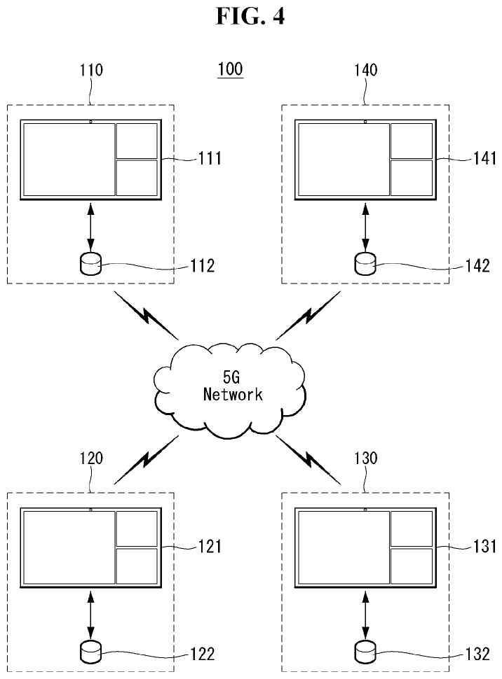

FIG. 4 illustrates a video conference system using an artificial intelligence according to an embodiment of the present disclosure.

Referring to FIG. 4, a video conference system 100 using a plurality of artificial intelligences according to an embodiment of the present disclosure may transmit or receive signals and information using a 5G network.

The video conference system 100 using the plurality of artificial intelligences may include a first video conference system 110 to a fourth video conference system 140. The video conference system may be referred to as a video conference system using an artificial intelligence. The video conference system using the artificial intelligence includes an intelligent conference-assisting device and a display device.

The first video conference system 110 may be installed in a first conference room. The first video conference system 110 may include a first intelligent conference-assisting device 112 and a first display device 111.

The first intelligent conference-assisting device 112 may be trained based on content of conference between a first user group and a second user group generated from tele-conference between the first user group and the second user group and respond to a command voice uttered in the first user group or the second user group among the trained conference content to support the tele-conference. The second user group may be located in one of a second conference room to a fourth conference room.

The first display device 111 may receive a response corresponding to the command voice from the first intelligent conference-assisting device 112 and display the received response.

A second video conference system 120 may be installed in the second conference room located remotely from the first conference room. The second video conference system 120 may include a second intelligent conference-assisting device 122 and a second display device 121.

A third video conference system 130 may be installed in a third conference room located remotely from the first and the second conference rooms. The third video conference system 130 may include a third intelligent conference-assisting device 132 and a third display device 131.

The fourth video conference system 140 may be installed in a fourth conference room located remotely from the first, second, and third conference rooms. The fourth video conference system 140 may include a fourth intelligent conference-assisting device 142 and a fourth display device 141.

For example, the first intelligent conference-assisting device 112 may be referred to as a main intelligent conference-assisting device. Further, the second, third, and fourth intelligent conference-assisting devices 122, 132, and 142 may be referred to as slave intelligent conference-assisting devices. The present disclosure is not limited thereto, and one of the second, third, and fourth intelligent conference-assisting devices 122, 132, and 142 may be the main intelligent conference-assisting device. The remaining intelligent conference-assisting devices may become slave intelligent conference-assisting devices.

The main intelligent conference-assisting device may remotely control at least one slave intelligent conference-assisting device or transmit a signal or information using a 5G network. In addition, the main intelligent conference-assisting device may be connected to the second display device 121 to the fourth display device 141 in addition to the first display device 111 via the 5G network to transmit the signal or information to the first to fourth display devices 111 to 141.

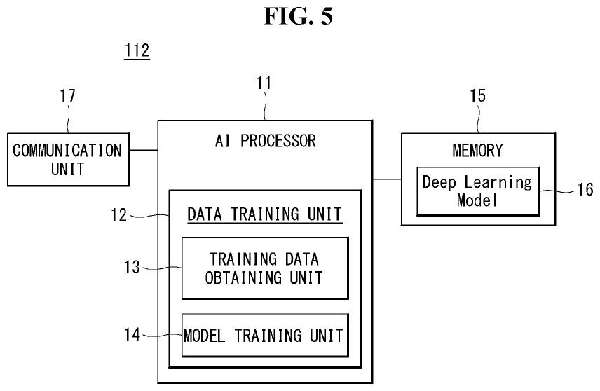

FIG. 5 is a block diagram of an intelligent conference-assisting device according to an embodiment of the present disclosure.

In FIG. 5, the first intelligent conference-assisting device 112 will be mainly described. Since the second intelligent conference-assisting device 122 to the fourth intelligent conference-assisting device 142 have substantially the same configuration and function as the first intelligent conference-assisting device 112, a description thereof will be omitted. Hereinafter, the first intelligent conference-assisting device 112 will be described as the intelligent conference-assisting device 112 for convenience of description.

Referring to FIG. 5, the intelligent conference-assisting device 112 may include an electronic device including an AI module capable of performing AI processing. The intelligent conference-assisting device 112 may be referred to as an AI device or an AI agent.

In addition, the intelligent conference-assisting device 112 may be included as at least a component in the video conference system 100 using the artificial intelligence shown in FIG. 4 to perform at least a portion of the AI processing together.

The AI processing may include all operations related to control of the video conference system 100 using the artificial intelligence illustrated in FIG. 4. For example, the video conference system 100 using the artificial intelligence may AI process sensing data transmitted or data obtained from the intelligent conference-assisting device 112 to perform operation of process/determination and control signal generation. In addition, for example, the intelligent conference-assisting device 112 may AI process data received via a communication unit 17 to perform control of the video conference system 100 using the artificial intelligence.

The intelligent conference-assisting device 112 may be a client device that directly uses the AI processing result.

The intelligent conference-assisting device 112 may include an AI processor 11, a memory 15, and/or a communication unit 17.

The intelligent conference-assisting device 112, which is a computing device capable of learning neural networks, may be implemented as various electronic devices such as a server, a desktop PC, a laptop PC, a tablet PC, and the like.

The AI processor 11 may learn the neural network using a program stored in the memory 15. In particular, the AI processor 11 may learn the neural network for recognizing data related to the video conference system 100 using the artificial intelligence. For example, the AI processor 11 may learn the neural network for recognizing contextual information (e.g., various information related to a user recognized to have uttered a command voice and various information related to a speaker who uttered the command voice) related to a command voice uttered after a wake up voice.

The neural network for recognizing data related to the video conference system 100 using the artificial intelligence may be designed to simulate a human brain structure on a computer and may include a plurality of network nodes having weights that simulate neurons of a human neural network. Each of the plurality of network nodes may transmit and receive data based on a connection relationship, so that neurons simulate a synaptic activity of the neurons that transmit and receive signals through synapses. In this connection, the neural network may include a deep learning model developed from a neural network model. In the deep learning model, a plurality of network nodes may be located at different layers and exchange data based on a convolution connection relationship. Examples of the neural network model includes various deep learning technologies such as DNNs (deep neural networks), CNNs (convolutional deep neural networks), a RNN (Recurrent Boltzmann Machine), a RBM (Restricted Boltzmann Machine), DBNs (deep belief networks), and a deep Q-Network and the neural network model may be applied to fields such as computer vision, voice recognition, natural language processing, and voice/signal processing.

In one example, the processor performing the function as described above may be a general purpose processor (e.g., CPU), but may be an AI dedicated processor (e.g., GPU) for artificial intelligence learning.

The memory 15 may store various programs and data necessary for the operation of the intelligent conference-assisting device 112. The memory 15 may be implemented as a nonvolatile memory, a volatile memory, a flash memory, a hard disk drive (HDD), a solid state drive (SDD), or the like. The memory 15 is accessed by the AI processor 11 and may perform data read/write/modification/deletion/update, and the like by the AI processor 11. In addition, the memory 15 may store a neural network model (e.g., a deep learning model 16) generated through a learning algorithm for classifying/recognizing data according to an embodiment of the present disclosure.

In one example, the AI processor 11 may include a data training unit 12 for training a neural network for data classification/recognition. The data training unit 12 may learn a criterion about which training data to use to determine the data classification/recognition and how to classify and recognize the data using the training data. The data training unit 12 may obtain the training data to be used for the training and apply the obtained training data to the deep learning model, thereby training the deep learning model.

The data training unit 12 may be produced in a form of at least one hardware chip and mounted on an AI device 112. For example, the data training unit 12 may be produced in a form of a dedicated hardware chip for the artificial intelligence (AI) or may be produced as a part of the general purpose processor (CPU) or the graphics-dedicated processor (GPU) and mounted on the intelligent conference-assisting device 112. Further, the data training unit 12 may be implemented as a software module. When the data training unit 12 is implemented as a software module (or a program module containing instructions), the software module may be stored in a non-transitory computer readable medium that may be read by a computer. In this case, at least one software module may be provided by an OS (operating system) or by an application.

The data training unit 12 may include a training data obtaining unit 13 and a model training unit 14.

The training data obtaining unit 13 may obtain the training data necessary for the neural network model for classifying and recognizing the data. For example, the training data obtaining unit 13 may obtain various data and/or sample data related to the conference content for inputting into the neural network as the training data.

The model training unit 14 may train the neural network model to have a determination criterion about how to classify the predetermined data, using the obtained training data. In this connection, the model training unit 14 may train the neural network model through supervised learning using at least a portion of the training data as the determination criterion. Alternatively, the model training unit 14 may train the neural network model using unsupervised learning that discovers the determination criterion by learning itself using the training data without the supervision. Further, the model training unit 14 may train the neural network model using reinforcement learning using feedback on whether a result of situation determination based on the learning is correct. Further, the model training unit 14 may train the neural network model using a learning algorithm that includes error back-propagation or gradient decent.

When the neural network model is trained, the model training unit 14 may store the trained neural network model in the memory. The model training unit 14 may store the trained neural network model in a memory of a server connected to the intelligent conference-assisting device 112 via a wired or wireless network.

The data training unit 12 may further include a training data preprocessing unit (not shown) and a training data selection unit (not shown) to improve analysis results of a recognition model or to save resources or time required for generating the recognition model.

The training data preprocessing unit may preprocess obtained data such that the obtained data may be used for the training for the situation determination. For example, the training data preprocessing unit may process the obtained data into a preset format such that the model training unit 14 may use obtained training data for learning for the image recognition.

Further, the training data selection unit may select data required for the training from the training data obtained in the training data obtaining unit 13 or the training data preprocessed in the preprocessing unit. The selected training data may be provided to the model training unit 14. For example, the training data selection unit may detect content related to agenda or topic of the video conference content acquired via the intelligent conference-assisting device 112 to select only data of a specific object included in the conference content as the training data.

Further, the data training unit 12 may further include a model evaluation unit (not shown) to improve an analysis result of the neural network model.

When evaluation data is input to the neural network model and an analysis result output from the evaluation data does not satisfy a predetermined criterion, the model evaluation unit may allow the model training unit 12 to be trained again. In this case, the evaluation data may be predefined data for evaluating the recognition model. In one example, when the number or a ratio of evaluation data with an inaccurate analysis result among the analysis results of the trained recognition model on the evaluation data exceeds a preset threshold, the model evaluation unit may evaluate that the predetermined criterion is not satisfied.

The communication unit 17 may transmit the AI processing result by the AI processor 11 to the video conference system 100 using an artificial intelligence located at a short distance or the video conference system 100 using another artificial intelligence located at a long distance.

In one example, in a case of the first video conference system 110 installed in the first conference room and the second video conference system 120 installed in the second conference room, communication between the first intelligent conference-assisting device 112 and the first display device 111 located at a short distance may be defined as the 5G network and communication between the first intelligent conference-assisting device 112 and the second intelligent conference-assisting device 122 or the second display device 121 located at a remote location may be defined as the 5G network.

In an example, the intelligent conference-assisting device 112 may be implemented by being functionally embedded in the processor provided in the video conference system 100 using the artificial intelligence. In addition, the 5G network may include a server or a module that performs the AI processing.

In an example, although the AI device 112 illustrated in FIG. 5 has been described functionally divided into the AI processor 11, the memory 15, the communication unit 17, and the like, it should be noted that the above-mentioned components may be integrated into one module and may be referred to as an AI module.

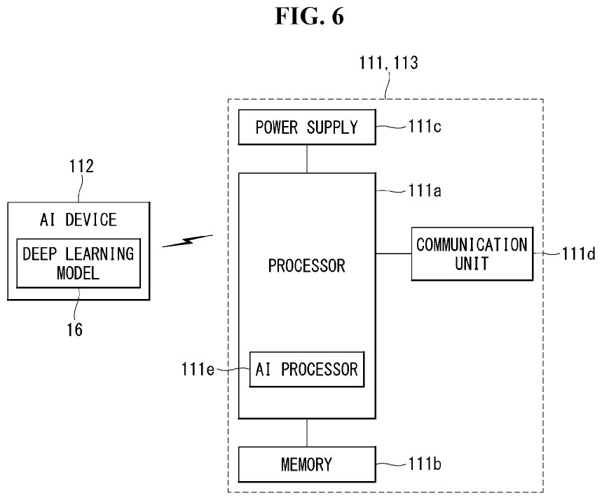

FIG. 6 is a diagram illustrating a server to which an intelligent conference-assisting device and a first intelligent conference-assisting device according to an embodiment are linked.

Referring to FIG. 6, a server 113 or the display device 111 may transmit data requiring the AI processing to the intelligent conference-assisting device 112 via a communication unit 111d, and the intelligent conference-assisting device 112 including the deep learning model 16 may transmit an AI processing result using the deep learning model 16 to the server. The intelligent conference-assisting device 112 may refer to the content described in FIG. 5.

In FIG. 6, the first display device 111 will be mainly described. Since the second display device 121 to the fourth display device 141 have substantially the same configuration and function as the first display device 111, a description thereof will be omitted. Hereinafter, the first display device 111 will be described as a display device 111 for convenience of description.

The display device 111 or the server 113 may include a memory 111b, a processor 111a, and a power supply 111c. Further, the processor 111a may further include an AI processor 111e.

The memory 111b is electrically connected to the processor 111a. The memory 111b may store basic data for the display device 111 or the server 113, control data for controlling an operation of the display device 111 or the server 113, and data inputted or outputted. The memory 111b may store data processed by the processor 111a. The memory 111b may be configured in hardware as at least one of a ROM, a RAM, an EPROM, a flash drive, and a hard drive. The memory 111b may store various data for the overall operation of the video conference system 100 using the artificial intelligence, such as a program for processing or controlling of the processor 111a. The memory 111b may be integrated with the processor 111a. According to an embodiment, the memory 111b may be classified into a lower configuration of the processor 111a.

The power supply 111c may supply power to the display device 111 or the server 113. The power supply 111c may receive power from a power source (e.g., a battery) included in the display device 111 or the server 113 and supply the received power to each unit of the display device 111 or the server 113. The power supply 111c may be operated based on a control signal provided from a main ECU 240. The power supply 111c may include a switched-mode power supply (SMPS).

The processor 111a may be electrically connected to the memory 111b, an interface unit 280, and the power supply 111c to exchange signals with each other. The processor 111a may be implemented using at least one of ASICs (application specific integrated circuits), DSPs (digital signal processors), DSPDs (digital signal processing devices), PLDs (programmable logic devices), FPGAs (field programmable gate arrays), processors, controllers, micro-controllers, microprocessors, and electrical units for performing other functions.

The processor 111a may be driven by the power provided from the power supply 111c. The processor 111a may receive data, process the data, generate a signal, and provide the signal while the power is supplied by the power supply 111c.

The processor 111a may receive information from the display device 111 or another electronic device in the server 113.

The display device 111 or the server 113 may include at least one printed circuit board (PCB). The memory 111b, the power supply 111c, and the processor 111a may be electrically connected to the printed circuit board.

Hereinafter, in the video conference system 100 using the artificial intelligence of the present disclosure, the AI processor 111e mounted on at least one of the intelligent conference-assisting device 112, the display device 111, and the server 113 will be described in more detail.

In one example, the intelligent conference-assisting device 112 may transmit information about the wake up voice or the command voice (e.g., wake up voice or command voice information related to a time zone in which the wake up voice or command voice was uttered and wake up voice or command voice information related to the user who is recognized to have uttered the wake up voice or command voice) to the display device 111 or the server 113 through the communication unit 111d. The intelligent conference-assisting device 112 may transmit AI processing data generated by applying the neural network model 26 to the transmitted data to the remote or neighboring display device 111 or the server 113.

That is, the video conference system 100 using the artificial intelligence learns the content of the video conference based on the AI processing data, detect the wake up voice of user or speaker from the learned content of the video conference, and accurately recognize the command voice transmitted after the detected wake up voice to provide a user's response such as data, material, or the like corresponding to the command voice rapidly. The communication unit 111d may exchange signals with the video conference system using the artificial intelligence located externally. In addition, the communication unit 111d may exchange signals with at least one of an infrastructure (e.g., a server and a broadcasting station), an IoT device, and a terminal. The communication unit 111d may include at least one of a transmission antenna, a reception antenna, a radio frequency (RF) circuit capable of implementing various communication protocols, and an RF element to perform communication.

In one example, the AI processor 111E may transmit information about the wake up voice or command voice (e.g., command voice information related to a time zone in which the wake up voice was uttered and command voice information related to the user who is recognized to have uttered the wake up) transmitted from each IoT device to at least one of the intelligent conference-assisting device, the display device, or the server.

According to an embodiment of the present disclosure, the communication unit 111d may acquire the wake up voice or the command voice among the learned content of the conference. The communication unit 111d may deliver the obtained wake up voice or command voice to the processor 111a.

According to an embodiment of the present disclosure, the processor 111a may extract or predict data or information necessary for the conference content intended by the user or the speaker using the wake up voice or the command voice transmitted from the communication unit 111d. The processor 111a may be controlled to select an appropriate response among various responses corresponding to the command voice based on the learned conference content and provide the selected appropriate response to a plurality of conference rooms in which video conference is ongoing to display the selected appropriate response therein.

Hereinabove, referring to FIGS. 1 to 6, content of the 5G communication necessary for implementing the video conference system 100 using the artificial intelligence according to an embodiment of the present disclosure, the AI processing by applying the 5G communication, and transmission and reception of the AI processing result was described.

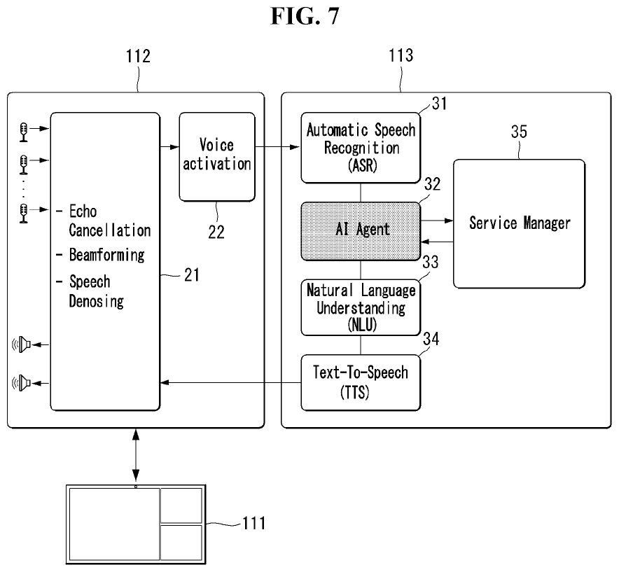

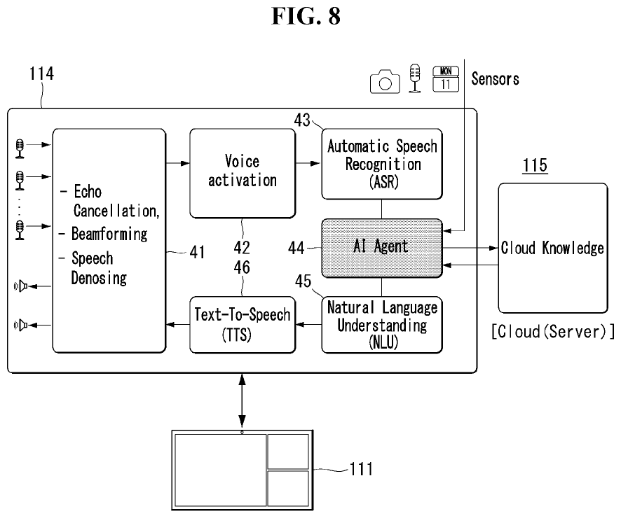

Hereinafter, according to an embodiment of the present disclosure, FIGS. 7 and 8 may describe a process of processing an audio of conference content during a video conference by the intelligent conference-assisting device 112. FIG. 7 illustrates an example in which a voice is processed between the intelligent conference-assisting device 112 and the server 113 according to an embodiment of the present disclosure, but an overall operation of the voice processing is performed in the server 113. For example, the server 113 may be referred to as a cloud.

In contrast, FIG. 8 illustrates an example of on-device processing in which a voice is processed between the intelligent conference-assisting device 112 and the server 113 according to an embodiment of the present disclosure, but an overall operation of the voice processing is performed in the intelligent conference-assisting device 112.

FIG. 7 illustrates a schematic block diagram of the intelligent conference-assisting device 112 and the server 113 in the video conference system 100 using the artificial intelligence according to an embodiment of the present disclosure.

As shown in FIG. 7, the intelligent conference-assisting device 112 of the present disclosure may require various components to process a voice event in an end-to-end voice UI environment.

A sequence that processes the voice event may perform signal acquisition and playback, speech pre-processing, voice activation, speech recognition, natural language processing, and speech synthesis, which is a final response of the device to the user.

The intelligent conference-assisting device 112 may include an input module. The input module may receive user input from the user. The input module may be referred to as an input unit. For example, the input module may include at least one microphone (MIC) capable of receiving a user's speech as a voice signal. The input module may include a speech input system. The input module may receive the user's speech as the voice signal via the speech input system. The at least one microphone may generate an input signal for an audio input, thereby determining a digital input signal for the user's speech.

According to one embodiment, a plurality of microphones may be implemented in an array. The array may be arranged in a geometric pattern, for example, a linear geometric form, a circular geometric form, or in any other configuration. For example, an array of four sensors may be arranged in a circular pattern for a predetermined point, in which the four sensors are separated from each other by 90 degrees to receive sounds from four directions. In some implementations, the microphone may include spatially different arrays of sensors in data communication, which may be networked arrays of sensors. The microphone may include an omnidirectional microphone, a directional microphone (e.g., a shotgun microphone), and the like.

The intelligent conference-assisting device 112 may include a pre-processing module 21 capable of pre-processing a user input (voice signal) received through the input module (e.g., the microphone).

The pre-processing module 21 may include an adaptive echo canceller (AEC) function to remove echo included in the user voice signal input via the microphone. The pre-processing module 21 includes a noise suppression (NS) function to remove a background noise included in the user input. The pre-processing module 21 may include an end-point detect (EPD) function to detect an end-point of the user's voice to find a portion where the user's voice exists. In addition, the pre-processing module 21 includes an automatic gain control (AGC) function, so that a volume of the user input may be adjusted to be suitable for recognizing and processing the user input.

The intelligent conference-assisting device 112 may include a voice activation module 22. The voice activation module 22 may recognize a wake up command that recognizes a user's call. The wake up command may be referred to as a wake up voice. The voice activation module 22 may detect or sense a predetermined keyword (e.g., Hi LG) from the user input that has been pre-processed. The voice activation module 22 may be in a standby state to perform an always-on keyword detection function.

The intelligent conference-assisting device 112 may transmit the user voice input to the server 113. Auto speech recognition (ASR) and natural language understanding (NLU) operations, which are key operations for processing the user voice, may be performed in the server 113 in consideration of computing, storage, power constraints, and the like. The server 113 may process the user input transmitted from the intelligent conference-assisting device 112. The server 113 may exist in a cloud form.

The server 113 may include an auto speech recognition (ASR) module 31, an artificial intelligent agent 32, a natural language understanding (NLU) module 33, a text-to-speech (TTS) module 34, and a service manager 35.

The ASR module 31 may convert the user voice input received from the intelligent conference-assisting device 112 into text data.

The ASR module 31 may include a front-end speech pre-processor. The front-end speech pre-processor may extract representative features from the speech input. For example, the front-end speech pre-processor may perform Fourier transform on the speech input to extract a spectral feature that characterizes the speech input as a representative multi-dimensional vector sequence.

In addition, the ASR module 31 may include at least one speech recognition model (e.g., acoustic model and/or language model) and may implement at least one speech recognition engine. For example, the speech recognition model may include a hidden Markov model, a Gaussian-Mixture Model, a Deep Neural Network Model, an n-gram language model, and other statistical models. Examples of the speech recognition engine may include a dynamic time distortion-based engine and a weighted finite-state transducer (WFST)-based engine. At least one speech recognition model and at least one speech recognition engine may be used to process the extracted representative features of the front-end speech pre-processor in order to generate intermediate recognition results (e.g., phonemes, phoneme strings, and sub-words) and ultimately text recognition results (e.g., words, word strings, or sequences of tokens).

The ASR module 31 may generate recognition results that include a text string (e.g., words, or a sequence of words, or a sequence of tokens). The recognition results may be delivered to the natural language processing module 33 for intent inference under control of the ASR module 31. For example, the ASR module 31 may generate a number of candidate textual representations of the speech input. Each candidate textual representation may be the sequence of the words or the tokens corresponding to the speech input.

The natural language processing (NLU) module 33 may perform syntactic analysis or semantic analysis to determine user intent. The NLU module 33 may be referred to as a natural language understanding module. The syntactic analysis may divide grammatical units (e.g., words, phrases, morphemes, or the like) and identify what grammatical elements the divided unit has. The semantic analysis may be performed using semantic matching, rule matching, formula matching, and the like. Accordingly, the NLU module 33 may obtain a domain, an intent, or a parameter required for the user input to represent the intent.

The NLU module 33 may determine the intent of the user and the parameter using mapping rules divided into the domain, intent, and parameter required for determining the intent. For example, one domain (e.g., alarm) may include a plurality of intents (e.g., alarm setting, alarm cancellation) and one intent may include a plurality of parameters (e.g., time, the number of repetitions, alarm sound, or the like). For example, a plurality of rules may include at least one essential element parameter. Matching rules may be stored in a natural language understanding database.

The NLU module 33 may identify a meaning of a word extracted from the user input using linguistic features (e.g., grammatical elements) such as a morpheme, a phrase, or the like and match the identified meaning of the word to the domain and the intent to determine the intent of the user. For example, the NLU module 33 may learn how many words extracted from the user input are included in each domain and intent and determine the user intent.

According to one embodiment, the NLU module 33 may determine the parameter of the user input using the words on which the intent determination is based. According to one embodiment, the NLU module 33 may determine the intent of the user using the natural language recognition database in which the linguistic features for determining the intent of the user input are stored.

In addition, according to one embodiment, the NLU module 33 may determine the user intent using a personal language model (PLM). For example, the NLU module 33 may use personalized information to determine the user intent. For example, the personalized information may include a contact list, a music list, schedule information, social network information, and the like. For example, the personal language model may be stored in the natural language recognition database. According to an embodiment, not only the NLU module 33 but also the ASR module 31 may recognize the user voice by referring to the personal language model stored in the natural language recognition database.

The NLU module 33 may further include a natural language generating module (not shown). The natural language generating module may change designated information into a text form. The information changed into the text form may be in a form of natural language speech. For example, the designated information may include information about additional input, information for guiding completion of an operation corresponding to the user input, information for guiding the additional input of the user, and the like. The information changed into the text form may be transmitted to the display device via the intelligent conference-assisting device 112 and displayed on the display, or may be transmitted to the TTS module and changed into a voice form. The TTS module 34 may change the information in the text form into information in a voice form.

The TTS module 34 may receive the information in the text form from the natural language generating module of the NLU module 33, change the information in the text form into the information in the voice form, transmit the information in the voice form to the intelligent conference-assisting device 112 or to the display device. The intelligent conference-assisting device 112 or the display device may output the information in the voice form via the speaker.

The TTS module 34 may synthesize speech output based on a provided text. For example, the result generated by the auto speech recognition (ASR) module 21 may be in a form of a text string. The TTS module 34 may convert the text string into audible speech output. The TTS module 34 uses any suitable speech synthesis technique to generate the speech output from the text. The TTS module 34 may include concatenative synthesis, unit selection synthesis, diphone synthesis, domain-specific synthesis, formant synthesis, articulatory synthesis, hidden Markov model (HMM)-based synthesis, and sinewave synthesis, but is not limited thereto.

In some examples, the TTS module 34 may be configured to synthesize individual words based on a phoneme string corresponding to the words. For example, the phoneme string may be associated with a word of the generated text string. The phoneme string may be stored in metadata associated with the word. The TTS module 34 may be configured to directly process the phoneme string in the metadata to synthesize words in a speech form.

Since the server 113 generally has more processing power or resources than the intelligent conference-assisting device 112, the server 113 may obtain a speech output of a higher quality than the actual one in synthesis at the intelligent conference-assisting device 112. However, the present disclosure is not limited thereto, and in fact, the speech synthesis process may be performed at the intelligent conference-assisting device 112.

In one example, according to one embodiment of the present disclosure, the server 113 may further include the artificial intelligent agent 32. The artificial intelligent agent 32 may be referred to as an AI agent. The artificial intelligent agent 32 may be designed to perform at least some of the functions performed by the ASR module 31, the NLU module 22, and/or the TTS module 34 described above. Further, the artificial intelligent agent module 22 may also contribute to performing independent functions of each of the ASR module 31, the NLU module 22, and/or the TTS module 34.

The artificial intelligent agent module 22 may perform the above-described functions via deep learning. A lot of research on the deep learning (research on how to create better representation techniques and how to build models to learn the better representation techniques) is being carried out to represent data in a form that may be understood by a computer (e.g., representing pixel information as a column vector in case of an image) and apply the data in learning. As a result of these efforts, the various deep learning technologies such as the DNNs (deep neural networks), the CNNs (convolutional deep neural networks), the RNN (Recurrent Boltzmann Machine), the RBM (Restricted Boltzmann Machine), the DBNs (deep belief networks), and the deep Q-Network may be applied to the fields such as the computer vision, the voice recognition, the natural language processing, and the voice/signal processing.

Currently, all major commercial speech recognition systems (MS Cortana, Skype Translator, Google Now, Apple Siri, or the like) are based on the deep learning techniques.

In particular, the artificial intelligent agent module 22 may perform various natural language processing processes, including machine translation, emotion analysis, and information retrieval, using a deep artificial neural network structure in the natural language processing field.

In an example, the server 113 may include the service manager 35 that may support the function of the artificial intelligent agent 32 by collecting various personalized information. The personalized information obtained via the service manager 35 may include at least one data (such as usage of a calendar application, a messaging service, a music application, or the like) used by the intelligent conference-assisting device 112 via the server 113, at least one sensing data collected by the intelligent conference-assisting device 112 and/or the server 113 (a camera, a microphone, a temperature sensor, a humidity sensor, a gyro sensor, a C-V2X, a pulse, ambient light, Iris scan, or the like), and off device data, which is not directly related to the intelligent conference-assisting device 112. For example, the personalized information may include maps, SMS, News, music, stock, weather, wikipedia information.

The artificial intelligent agent 32 is represented as a separate block to be distinguished from the ASR module 31, the NLU module 33, and the TTS module 34 for convenience of description, but the artificial intelligent agent 32 may perform at least some or all of the functions of each module 31, 32, and 34.

The intelligent conference-assisting device 112 or the server 113 described above may be electrically connected to the display device 111. The display device 111 may display data or information received from the intelligent conference-assisting device 112 or the server 113.

Hereinabove, the example in which the artificial intelligent agent 32 is implemented on the server 113 due to computing operation, storage, power constraint, or the like, but is not limited thereto.

For example, FIG. 8 may be the same as shown in FIG. 7 except a case in which the artificial intelligent agent (AI agent) is included in the intelligent conference-assisting device.

FIG. 8 illustrates a schematic block diagram of an intelligent conference-assisting device 114 and a server 115 according to another embodiment of the present disclosure.

The intelligent conference-assisting device and the server shown in FIG. 8 has some differences in configuration and functions thereof but may correspond to the intelligent conference-assisting device and the server referred in FIG. 7. Accordingly, a specific function of a corresponding block may be referred to FIG. 7.

Referring to FIG. 8, the intelligent conference-assisting device may include a pre-processing module 41, a voice activation module 42, an ASR module 43, an artificial intelligent agent 44, an NLU module 45, and a TTS module 46. In addition, the intelligent conference-assisting device may include an input module (at least one microphone) and at least one output module.

In addition, the server 115 may include cloud knowledge for storing information related to the conference content in a form of knowledge.

Functions of each module shown in FIG. 8 may refer to FIG. 7. However, since the ASR module 43, the NLU module 45, and the TTS module 46 are included in the intelligent conference-assisting device 114, communication with the cloud 115 may not be required for the voice processing such as the speech recognition and the speech synthesis, thereby enabling immediate and real-time voice processing.

Each module illustrated in FIGS. 7 and 8 is merely an example for describing the voice processing process, and more or fewer modules than those illustrated in FIGS. 7 and 8 may be included. It should also be noted that at least two modules may be combined with each other or different modules or modules of different arrangements may be included.

The various modules illustrated in FIGS. 7 and 8 may be implemented in at least one signal processing and/or custom integrated circuit, hardware, software instructions for execution by at least one processor, firmware, or combinations thereof.

The intelligent conference-assisting device 114 or the server 115 described above may be electrically connected to the display device 111. The display device 111 may display the data or information received from the intelligent conference-assisting device 114 or the server 115.

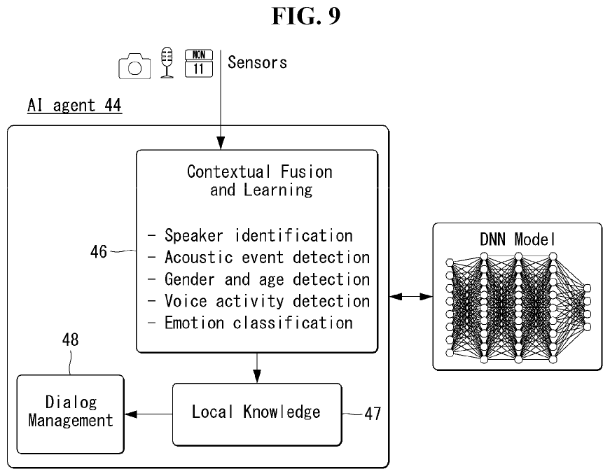

FIG. 9 illustrates a schematic block diagram of an artificial intelligent agent that may implement speech synthesis according to an embodiment of the present disclosure.

Referring to FIG. 9, the artificial intelligent agent 44 may support an interactive operation with the user in addition to performing the ASR operation, the NLU operation, and the TTS operation in the voice processing described with reference to FIGS. 7 and 8. Alternatively, the artificial intelligent agent 44 may use context information to contribute performing an operation of the NLU module 45 to clarify, supplement, or additionally define information included in the text representations received from the ASR module 43.

For example, the context information may include preferences of the users using the intelligent conference-assisting devices 112 and 114 (see FIGS. 7 and 8), hardware and/or software states of the intelligent conference-assisting devices 112 and 114 (see FIGS. 7 and 8), various sensor information collected before, during, or immediately after the user input, previous interactions between the artificial intelligent agent 44 and the user (e.g., conversations), and the like. The context information described above is dynamic and may include features that may vary depending on time, location, content of conversation, and other elements.

The artificial intelligent agent 44 may further include a contextual fusion and learning module 46, a local knowledge 47, and a dialog management 48.

The contextual fusion and learning module 46 may learn the user's intent based on at least one data. The at least one data may include at least one sensing data obtained from the intelligent conference-assisting devices 112 and 114 (see FIGS. 7 and 8) or the servers 113 and 115 (see FIGS. 7 and 8). In addition, the at least one data may include speaker identification, acoustic event detection, video conference content, voice activity detection (VAD), and emotion classification.

The speaker identification may mean specifying a person speaking in a conversation group registered by a voice. The speaker identification may include processes of identifying a registered speaker or registering the speaker as a new speaker.

The acoustic event detection may recognize a sound itself beyond the speech recognition technology to recognize a type of sound and an occurrence location of the sound.

The voice activity detection (VAD) is a speech processing technique in which a presence or absence of human speech (voice) is detected in an audio signal that may include music, noise, or other sound. According to an example, the artificial intelligent agent 44 may identify the presence of the speech from the input audio signal. According to an example, the artificial intelligent agent 44 may distinguish the speech data and the non-speech data using the deep neural network (DNN) model.

In addition, the artificial intelligent agent 44 may use the deep neural network (DNN) model to analyze the speech data, extract core data from the analyzed speech data, and perform, based on the extracted core data or material, a search associated therewith.

The contextual fusion and learning module 46 may include the DNN model to perform the above-described operation. Further, the contextual fusion and learning module 46 may identify the intent of the user input based on the sensing information collected from the DNN model, client, or servers 113 and 115 (see FIGS. 7 and 8).

The at least one data is merely exemplary and may include any data that may be referred to identify the user's intent in the speech processing. The at least one data may be obtained via the above-described DNN model.

The artificial intelligent agent 44 may include the local knowledge 47. The local knowledge 47 may include conference data about the conference content. The conference data may include agenda or subject of the conference content, key words related to the conference content, surrounding words, set language, command voices, and the like. According to an example, the artificial intelligent agent 44 may additionally define the intent of the speaker by supplementing information included in the voice input of the speaker using specific information related to the command voice and the content of the conference. For example, in response to a user request, “Please show a graph of sales figures of companies that manufactured smartphones in 2018.”, the artificial intelligent agent 24 may not require the user to provide more clear information in order to search for “manufacturers of smartphones” and “sales figure” of each company, and use the local knowledge 47.

The artificial intelligent agent 44 may include the dialog management 48. The artificial intelligent agent 44 may provide a dialog interface to enable voice conversation with the user. The dialog interface may refer to a process of outputting a response to a user's voice input via the display or the speaker. In this connection, a final result output through the dialog interface may be based on the above-described ASR operation, NLU operation, and TTS operation.

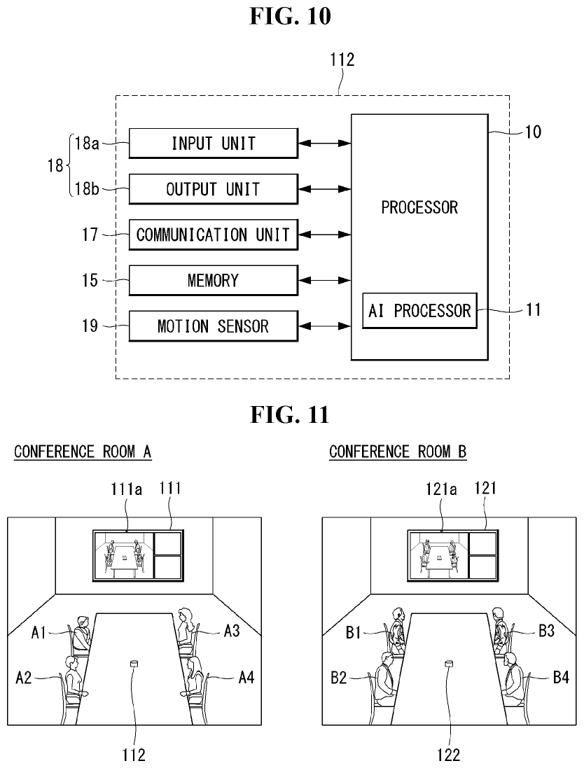

FIG. 10 illustrates a schematic block diagram of an intelligent conference-assisting device according to another embodiment of the present disclosure.

Referring to FIG. 10, an intelligent conference-assisting device 112 may include an input/output unit 18, a communication unit 17, a memory 15, a motion sensor 19, and a processor 10.

The input/output unit 18 may include an input unit 18a and an output unit 18b.

The input unit 18a may receive user input from the user. The input unit 18a may be referred to as an input module. A detailed description thereof has been described in FIG. 7 and will be omitted here. The input unit 18a may include a camera. The camera (not shown) may be mounted on an outer face of the intelligent conference-assisting device 112. The camera may capture a user who has uttered a wake up voice among the first user group under the control of the processor. The camera may capture the user and transmit the captured user's image to the processor. The communication unit 17 may transmit the image of the user captured under the control of the processor 10 to the display device 111 or the server 113 via the 5G network. The user may be referred to as a speaker.

The output unit 18b may output a voice form of another user during the video conference. The output unit 18b may be referred to as an output module. The output unit 18b may include a speaker (not shown). Although not shown, the output unit 18b may include a display unit (not shown). The display unit (not shown) may be mounted on an outer face of the intelligent conference-assisting device 112. The display unit may display a dialog uttered during the video conference in a text. In this connection, the content of converting the uttered dialog into the text has been described in detail in FIGS. 7 to 9 and thus the same will be omitted here. When the display unit includes a touch screen, the display unit may perform not only a function of the output unit 18b but also some functions of the input unit 18a.

The communication unit 17, the memory 15, and the processor 10 have been described in detail with reference to FIGS. 5 to 9, and thus a detailed description thereof will be omitted.

The motion sensor 19 may be mounted on the intelligent conference-assisting device to sense a motion of the user who utters. For example, the motion sensor 19 may detect the uttering user among the first user group, and sense the motion of the user based on the detected user.

When a specific action or a specific motion is detected, the motion sensor 19 may transmit the detected specific signal to the processor 10. When the specific signal is transmitted from the motion sensor 19, the processor 10 may determine the transmitted specific signal as a wake up voice. The motion sensor 19 may continuously detect the motion of the user after the specific motion detected under the control of the processor 10. That is, after receiving the specific signal, the processor 10 may control the motion sensor 19 to continuously detect the motion of the user and provide a response corresponding to the motion of the user.

For example, when the user moves a finger left or right after the specific signal is detected, the processor 10 may control to move a page displayed on the display device 111 to a next page in response to the user's finger movement.

FIG. 11 illustrates a video conference system using an artificial intelligence installed in a conference room according to an embodiment of the present disclosure.

Referring to FIG. 11, the video conference system using the artificial intelligence according to an embodiment of the present disclosure may be installed or disposed in a conference room.

The first video conference system 110 may be installed in a conference room A. A first user group A1 to A4 may attend conference in the conference room A. The first user group A1 to A4 may include 11^{th} user A1 to 14^{th} user A4.

The first video conference system 110 may include the first intelligent conference-assisting device 112, the first display device 111, and a first server (not shown). Although not shown, the first server of the first video conference system 110 may be disposed at a place other than the conference room A to transmit information or signals using the 5G network. For example, the first server may be a cloud.

The first intelligent conference-assisting device 112 may be trained based on conference content between the first user group A1 to A4 and a second user group B1 to B4 generated in tele-conference between the first user group A1 to A4 and the second user group B1 to B4 and response corresponding to a command voice uttered by the first user group A1 to A4 or the second user group B1 to B4 among the learned conference content to support the tele-conference.

The first display device 111 may receive the response corresponding to the command voice from the first intelligent conference-assisting device 112 and display the received response. The first display device 111 may include a first camera 111a. The first camera 111a may be disposed near an upper end of a front face of the first display device 111.

The first camera 111a may capture the first user group A1 to A4 or a speaker in the conference room A. The first display device 111 may be divided into at least one screen. The first display device 111 may display the first user group A1 to A4 or the speaker captured by the first camera 111a on one of the divided screens. The first display device 111 may display the second user group B1 to B4 or a speaker captured by the second camera 121a on one of the divided screens under control of the first intelligent conference-assisting device 112.

In addition, the first display device 111 may display data or information related to the conference provided from the first intelligent conference-assisting device 112 on one of the divided screens under the control of the first intelligent conference-assisting device 112.

The second video conference system 120 may be installed in a conference room B. The second user group B1 to B4 may attend conference in the conference room B. The second user group B1 to B4 may include 21th user B1 to 24^{th} user B4.

The second video conference system 120 may include the second intelligent conference-assisting device 122, the second display device 121, and a second server (not shown). Although not shown, the second server of the second video conference system 120 may be disposed at a place other than the conference room B to transmit information or signals using the 5G network. For example, the second server may be a cloud.

The second intelligent conference-assisting device 122 may be trained based on the conference content between the first user group A1 to A4 and the second user group B1 to B4 generated in tele-conference between the first user group A1 to A4 and the second user group B1 to B4 and response corresponding to the command voice uttered by the first user group A1 to A4 or the second user group B1 to B4 among the learned conference content to support the tele-conference.

The second display device 121 may receive the response corresponding to the command voice from the second intelligent conference-assisting device 122 and display the received response. The second display device 121 may include a second camera 121a. The second camera 121a may be disposed near an upper end of a front face of the second display device 121.

The second camera 121a may capture the second user group B1 to B4 or a speaker in the conference room B. The second display device 121 may be divided into at least one screen. The second display device 121 may display the second user group B1 to B4 or the speaker captured by the second camera 121a on one of the divided screens. The second display device 121 may display the second user group B1 to B4 or the speaker captured by the second camera 121a on one of the divided screens under control of the second intelligent conference-assisting device 122.

In addition, the second display device 121 may display data or information related to the conference provided from the second intelligent conference-assisting device 122 on one of the divided screens under the control of the second intelligent conference-assisting device 122.

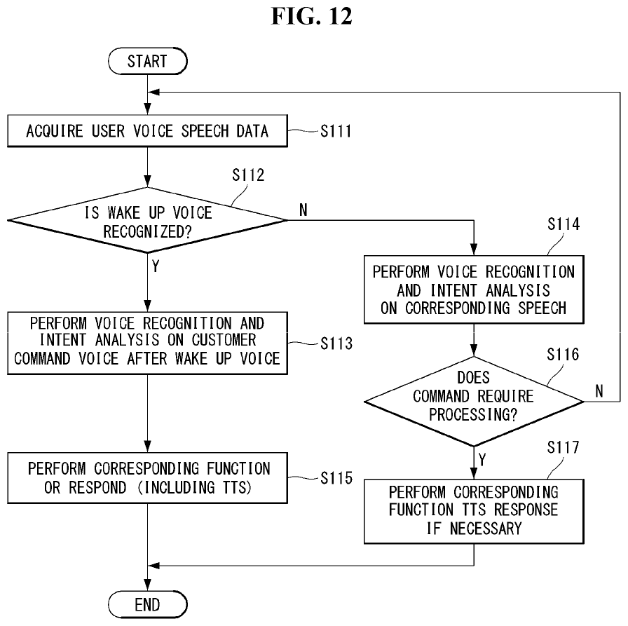

FIG. 12 is a diagram for briefly describing a method for implementing a video conference system using an artificial intelligence according to an embodiment of the present disclosure.

Referring to FIGS. 11 and 12, video conference may be started via a video conference system using an artificial intelligence according to an embodiment of the present disclosure.

The first user group A1 to A4 may attend the conference in the conference room A and the second user group B1 to B4 may attend the conference in the conference room B.

The first intelligent conference-assisting device 112 may acquire all voices uttered during the video conference. For example, a voice of the 11^{th} user among the first user group A1 to A4 may be detected. When the uttered voice is detected, the first intelligent conference-assisting device 112 may acquire data about the voice uttered by the 11^{th} user (S111).

The first intelligent conference-assisting device 112 may recognize or detect a wake up voice among the content of the conference (S112). When the wake up voice is recognized, the first intelligent conference-assisting device 112 may perform voice recognition and intent analysis on a customer command voice after the wake up voice (S113). When the wake up voice is recognized among the uttered voices, the first intelligent conference-assisting device 112 may recognize the voice for the customer command voice. The first intelligent conference-assisting device 112 may learn the recognized customer command voice and analyze the intent thereof. A detailed description thereof will be described below.

The first intelligent conference-assisting device 112 may perform a function or respond corresponding to the analyzed intent (S115). The function may be referred to as an application program.

Alternatively, the first intelligent conference-assisting device 112 may not recognize or detect the wake up voice among the content of the conference (S112). When the wake up voice is not recognized among the uttered voices, the first intelligent conference-assisting device 112 may perform the voice recognition and intent analysis on overall voices that are uttered (S114). That is, in overall conference content uttered by the 11^{th} user, the first intelligent conference-assisting device 112 may perform voice recognition and intent analysis on a corresponding speech. The first intelligent conference-assisting device 112 may learn the corresponding speech of the overall conference content and analyze the intent thereof.

The first intelligent conference-assisting device 112 may determine whether a command requires processing through the analyzed intent (S116). When the command is determined to be a command that does not require processing, the first intelligent conference-assisting device 112 may continuously acquire data on the voice uttered by the 11^{th} user (S111). When the command is determined to be a command that requires processing, the first intelligent conference-assisting device 112 may perform a function corresponding to the command that may be processed or response thereto (S117).

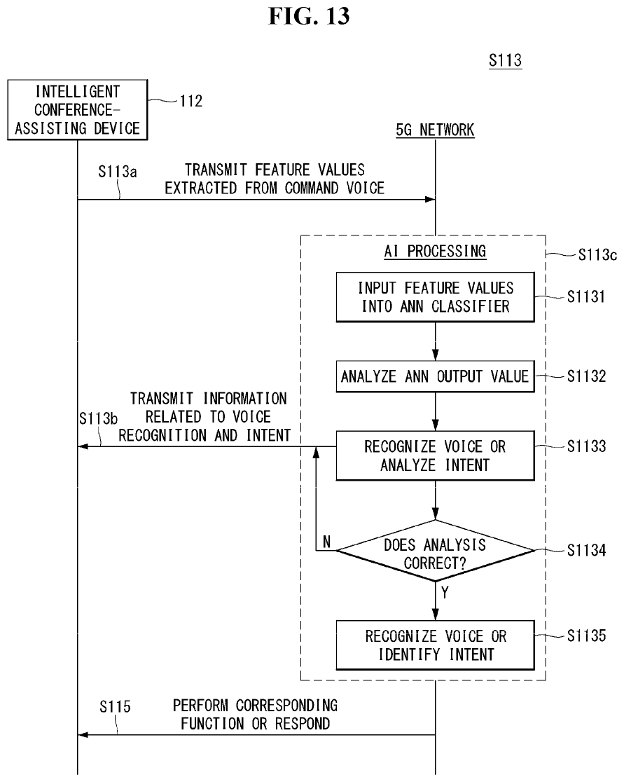

FIG. 13 is a diagram for illustrating an example of determining a command voice state in an embodiment of the present disclosure.

Referring to FIG. 13, the intelligent conference-assisting device 112 may learn conversation content between the first user group and the second user group. The intelligent conference-assisting device 112 may acquire user voice speech data that is the conversation content between the first user group and the second user group.

The intelligent conference-assisting device 112 may extract feature values from a command voice obtained via at least one sensor in order to recognize a voice of a speaker and analyze an intent thereof. For example, the intelligent conference-assisting device 112 may receive the command voice from at least one sensor (e.g., voice sensor and motion sensor). The intelligent conference-assisting device 112 may extract the feature values from the command voice. The feature values, which specifically indicate content recognized of intended by a speaker in a sentence or word uttered after the command voice of the speaker, are calculated from at least one feature that may be extracted from the command voice.

The intelligent conference-assisting device 112 may control the feature values to be input to an artificial neural network (ANN) classifier trained to recognize the speaker's voice or analyze the intent thereof.

The intelligent conference-assisting device 112 may recognize the command voice of the first user group and identify and analyze the intent thereof based on an application result output from the artificial neural network (ANN) classifier. That is, the intelligent conference-assisting device 112 may analyze the output value of the artificial neural network and may perform the voice recognition of the speaker or the determination of the intent thereof based on the output value of the artificial neural network.

The intelligent conference-assisting device 112 may recognize the voice of the speaker or identify a meaning of the intent thereof from the output of the artificial neural network (ANN) classifier.

In one example, in FIG. 13, an example in which the operation of recognizing the speaker's voice or identifying the meaning of the intent thereof is implemented in the processing of the intelligent conference-assisting device 112 is described, but the present disclosure is not limited thereto. For example, the AI processing may be performed on the 5G network based on information of the recognition of the speaker's voice or of the identification of the meaning of the intent received from the intelligent conference-assisting device 112.

As described above, referring to FIG. 13, the intelligent conference-assisting device 112 may control the communication unit to transmit the information of the recognition of the speaker's voice or of the identification of the meaning of the intent to the AI processor included in the 5G network. The information of the recognition of the speaker's voice or of the identification of the meaning of the intent may be referred to as information related to a situation in which the command voice is recognized.

In addition, the intelligent conference-assisting device 112 may control the communication unit to receive AI processed information from the AI processor.

The AI processed information may be information obtained by recognizing the command voice of the first group and identifying the intent thereof in the situation in which the command voice is recognized. That is, the AI processed information may be information that accurately recognizes the voice of the speaker or identifies the meaning of the intent thereof.

In one example, the intelligent conference-assisting device 112 may perform an initial access procedure to the 5G network in order to transmit the information of the recognition of the speaker's voice or of the identification of the meaning of the intent. The intelligent conference-assisting device 112 may perform the initial access procedure to the 5G network based on a synchronization signal block (SSB).

In addition, the intelligent conference-assisting device 112 may receive, via a wireless communication unit, downlink control information (DCI) from the network that is used to schedule transmission of the information of the recognition of the speaker's voice or of the identification of the meaning of the intent obtained from at least one sensor provided in the intelligent conference-assisting device.

The intelligent conference-assisting device 112 may transmit the information of the recognition of the speaker's voice or of the identification of the meaning of the intent to the network based on the DCI.

The information of the recognition of the speaker's voice or of the identification of the meaning of the intent is transmitted to the network through the PUSCH, a DM-RS of the SSB and the PUSCH may be QCLed (quasi co-located) for a QCL type D.

As shown in FIG. 13, the intelligent conference-assisting device 112 may transmit the feature values extracted from the command voice to the 5G network (S113a).

In this connection, the 5G network may include the AI processor or the AI system, and the AI system of the 5G network may perform the AI processing based on the received command voice (S113c).

The AI system may input the feature values received from the intelligent conference-assisting device 112 into the ANN classifier (S1131). The AI system may analyze the ANN output value (S1132) and recognize the voice of the speaker or analyze the meaning of the intent thereof from the ANN output value (S1133). The 5G network may transmit the recognized voice of the speaker or the meaning of the intent thereof from the AI system to the intelligent conference-assisting device 112 through the wireless communication unit.

When the recognition of the voice of the speaker or the identification of the meaning of the intent thereof is correct (S1134), the AI system may recognize the voice of the speaker or identify the meaning of the intent thereof (S1135), and perform a function corresponding thereto or respond (S115).

When the recognition of the voice of the speaker or the identification of the meaning of the intent thereof is wrong (s1134), the AI system may recognize the voice of the speaker or identify the meaning of the intent thereof again (S1133). In addition, the AI system may transmit the result of the recognition of the voice of the speaker or the identification of the meaning of the intent thereof to the intelligent conference-assisting device (S113b). The AI system may convert the result of the recognition of the voice of the speaker or the identification of the meaning of the intent thereof into data, information, or a signal and transmit the same to the intelligent conference-assisting device.

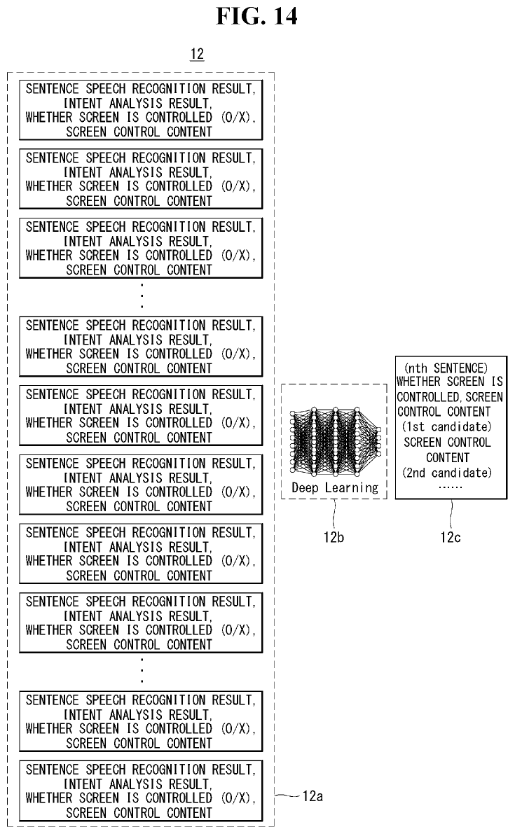

FIG. 14 is a diagram for illustrating training through a data training unit, according to an embodiment of the present disclosure.

Referring to FIG. 14, the intelligent conference-assisting device 112 may include a data training unit 12.

The data training unit 12 may learn a criterion about which training data to use to determine the data classification/recognition and how to classify and recognize the data using the training data. The data training unit 12 may obtain the training data to be used for the training and apply the obtained training data to the deep learning model, thereby training the deep learning model.

The data training unit 12 may include a data collection unit 12a for collecting various training data, a learning unit 12b for deep learning the collected data, and an output unit 12c for outputting the learned data.

The data collection unit 12a may collect a voice recognition result of a plurality of sentences uttered by the speakers during the video conference, an intent analysis result, whether the screen is controlled, and content of the screen control.

The learning unit 12b may learn the collected voice recognition result of the plurality of sentences, the intent analysis result, whether the screen is controlled, and the content of the screen control for each sentence to learn whether the screen control is required or control content thereof thereamong. That is, the learning unit 12b may be trained using a model of the speaker trained by considering an overall context and inputting front and rear sentences. A detailed description of the trained model has been described in detail above, and thus will be omitted.

The output unit 12c may present content corresponding thereto as an output result in response to each speech during the actual video conference based on the model trained under the control of the learning unit 12b.

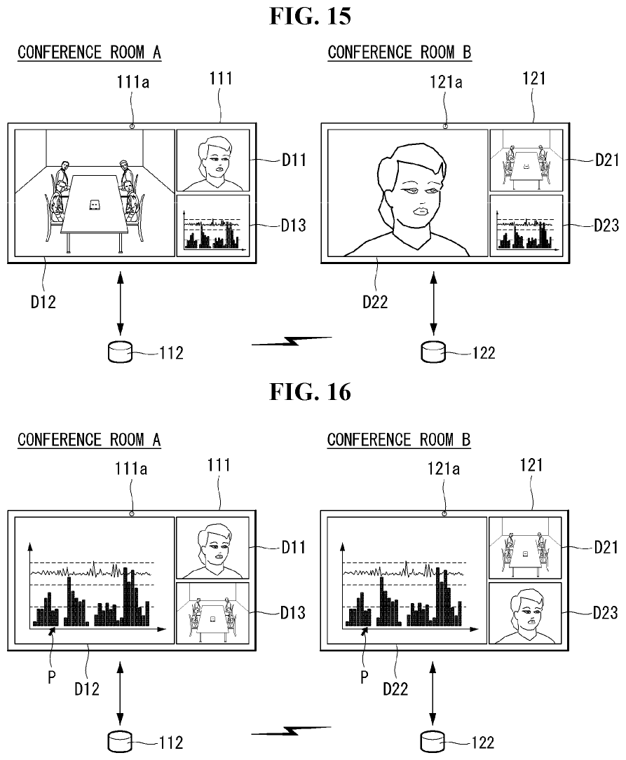

FIGS. 15 to 18 are diagrams for illustrating various examples displayed during a video conference according to an embodiment of the present disclosure.

Referring to FIG. 15, the first display device 111 disposed in the conference room A may divide a main screen displayed under control of the first intelligent conference-assisting device 112 into 11^{th} divided screen D11 to 13^{th} divided screen D13. The 11^{th} divided screen D11 may display an image of a speaker that is uttering among the first user group. A 12^{th} divided screen D12 may display an image of the second user group. The 13^{th} divided screen D13 may receive and display a function or response corresponding to the command voice of the first user group recognition and intent.

The first display device 111 may mount the first camera 111a on the front face thereof. Under the control of the first intelligent conference-assisting device 112, the first camera 111a may entirely capture the first user group who has attended the conference in the conference room A or focus on and capture a speaker who is uttering.

The second display device 121 disposed in the conference room B may divide a main screen displayed under control of the second intelligent conference-assisting device 122 into 21^{st} divided screen D21 to 23^{rd} divided screen D23. The 21^{st} divided screen D21 may display an image of the second user group. A 22^{nd} divided screen D22 may display an image of the speaker who is uttering among the first user group. The 23^{rd} divided screen D23 may receive and display the function or response corresponding to the command voice of the first user group recognition and intent.

The second display device 121 may mount the second camera 121a on the front face thereof. Under the control of the second intelligent conference-assisting device 122, the second camera 121a may entirely capture the second user group who has attended the conference in the conference room B or focus on and capture a speaker who is uttering.

Referring to FIG. 16, the first display device 111 disposed in the conference room A may divide the main screen displayed under the control of the first intelligent conference-assisting device 112 into the 11^{th} divided screen D11 to the 13^{th} divided screen D13. The 11^{th} divided screen D11 may display the image of the speaker that is uttering among the first user group. The 12^{th} divided screen D12 may receive and display the function or response corresponding to the command voice of the first user group recognition and intent. The 13^{th} divided screen D13 may display the image of the second user group.

The second display device 121 disposed in the conference room B may divide the main screen displayed under the control of the second intelligent conference-assisting device 122 into the 21^{st} divided screen D21 to the 23^{rd} divided screen D23. The 21^{st} divided screen D21 may display the image of the second user group. The 22^{nd} divided screen D22 may receive and display the function or response corresponding to the command voice of the first user group recognition and intent. The 23^{rd} divided screen D23 may display the image of the speaker who is uttering among the first user group.

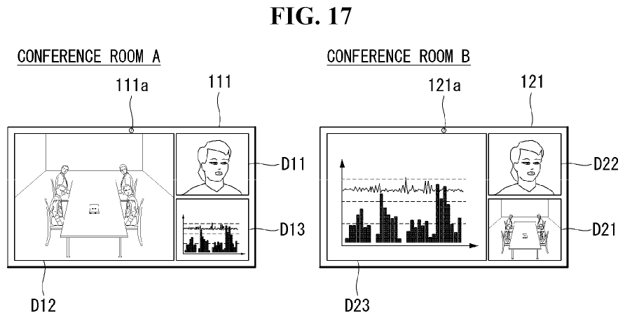

Referring to FIG. 17, the first display device 111 disposed in the conference room A may divide the main screen displayed under the control of the first intelligent conference-assisting device 112 into the 11^{th} divided screen D11 to the 13^{th} divided screen D13. The 11^{th} divided screen D11 may display the image of the speaker that is uttering among the first user group. The 12^{th} divided screen D12 may display the image of the second user group. The 13^{th} divided screen D13 may receive and display the function or response corresponding to the command voice of the first user group recognition and intent.

The second display device 121 disposed in the conference room B may divide the main screen displayed under the control of the second intelligent conference-assisting device 122 into the 21^{st} divided screen D21 to the 23^{rd} divided screen D23. The 21^{st} divided screen D21 may display the image of the speaker who is uttering among the first user group. The 22^{nd} divided screen D22 may receive and display the function or response corresponding to the command voice of the first user group recognition and intent. The 23^{rd} divided screen D23 may display the image of the second user group.

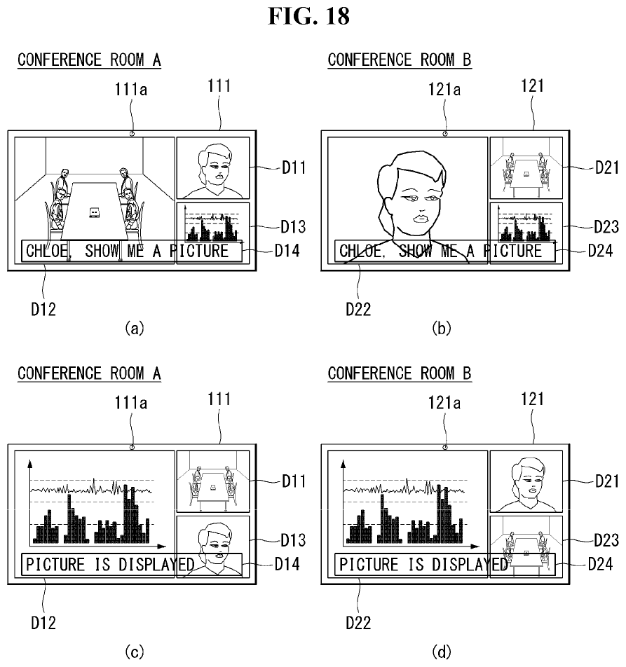

Referring to FIG. 18a, the first display device 111 disposed in the conference room A may divide the main screen displayed under the control of the first intelligent conference-assisting device 112 into the 11^{th} divided screen D11 to a 14^{th} divided screen D14. The 11^{th} divided screen D11 may display the image of the speaker that is uttering among the first user group. The 12^{th} divided screen D12 may display the image of the second user group. The 13^{th} divided screen D13 may receive and display the function or response corresponding to the command voice of the first user group recognition and intent. The 14^{th} divided screen D14 may convert conversation contents of the first user group and the second user group into text and display the converted text.

Referring to FIG. 18c, when a command voice of “Show me a picture” is detected together with a wake up voice of “Chloe” that is uttered by the speaker, the first intelligent conference-assisting device 112 may be controlled to display a graph corresponding to “Chloe, show me a picture” on the 12^{th} divided screen D12.

The first intelligent conference-assisting device 112 may display the corresponding graph on the 14^{th} divided screen D14 in response thereto.

Referring to FIG. 18b, the second display device 121 disposed in the conference room B may divide the main screen displayed under the control of the second intelligent conference-assisting device 122 into the 21^{st} divided screen D21 to a 24^{th} divided screen D24. The 21^{st} divided screen D21 may display the image of the second user group. The 22^{nd} divided screen D22 may display the image of the speaker who is uttering among the first user group. The 23^{rd} divided screen D23 may receive and display the function or response corresponding to the command voice of the first user group recognition and intent. The 24^{th} divided screen D24 may convert the conversation contents of the first user group and the second user group into text and display the converted text.

Referring to FIG. 18d, when the command voice of “Show me a picture” is detected together with the wake up voice of “Chloe” that is uttered by the speaker, the second intelligent conference-assisting device 122 may be controlled to display the graph corresponding to “Chloe, show me a picture” on the 22^{nd} divided screen D22.

The second intelligent conference-assisting device 122 may display the corresponding graph on the 24^{th} divided screen D24 in response thereto.

As described above, the display devices 111 and 121 may have the first divided screen to the third divided screen having different screen sizes under the control of the intelligent conference-assisting devices 112 and 122. For example, the second divided screen may be larger than the first divided screen and the third divided screen. In some cases, the function or response corresponding to the command voice of the first user group recognition and intent may be provided and displayed. Further, the third divided screen may display the image of the second user group.

For example, the intelligent conference-assisting devices 111 and 121 may recognize the command voice of the first user group or the second user group after the wake up voice, and may control the divided screens based on the recognized command voice.

In addition, the cameras 111a and 121a may capture the speaker or the user who uttered the wake up voice among the first user group under the control of the intelligent conference-assisting devices 112 and 122. The intelligent conference-assisting devices 112 and 122 may capture the user who has uttered the wake up voice or the command voice and provide the same to the display devices 111 and 121 to be displayed.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Effects of the video conference system using the artificial intelligence according to the present disclosure are as follows.

According to the present disclosure, the content of the video conference may learned during the video conference and the function required for the video conference may be performed in response to the command voice or the various information related to the video conference may be searched, thereby supporting the video conference to be smoothly progressed.

Further, according to the present disclosure, the data required for the video conference may be displayed in real time and shared during the video conference.

In addition, according to the present disclosure, indication information of a pointer indicated when data displayed on a display device is explained during the video conference is detected and transmitted to a display device of another conference room, thereby displaying the indication information of the pointer at a same position.

Further, according to the present disclosure, the data displayed on the display device may be remotely controlled via the conference-assisting device during the video conference.

What is claimed is:

1. A video conference system using an artificial intelligence, the video conference system comprising:
a conference-assisting device configured to:
learn conversation content of a conversation between a first user group and a second user group in a teleconference with the first user group,
in response to recognizing a preset wake voice in the conversation content during the teleconference, detect a command voice following the wake voice,
recognize the command voice and analyze an intent of the command voice based on the conversation content and the command voice, and
execute an operation corresponding to the command voice; and
a display device configured to:
display a first image of the first user group and a second image of the second user group, and
display a third image corresponding to the operation executed based on the command voice.

2. The video conference system of claim 1, wherein the operation includes executing a function, executing an application program, or responding with audio output or visual output.

3. The video conference system of claim 1, wherein the conference-assisting device includes:
a transceiver configured to:
transmit the command voice to the display device or transmit information corresponding to the operation executed based on the command voice to the display device; and
a processor configured to:
learn the conversation content of the conversation between the first user group and the second user group,
in response to recognizing the preset wake voice in the conversation content during the teleconference, detect the command voice following the wake voice,
recognize the command voice and analyze the intent of the command voice based on the conversation content and the command voice, and
execute the operation corresponding to the command voice.

4. The video conference system of claim 3, wherein the conference-assisting device further includes:
a camera configured to:
capture the first image of the first user group based on a control signal from the processor.

5. The video conference system of claim 4, wherein the camera is further configured to:
capture a focused image focused on a user who uttered the wake voice among the first user group based on another control signal from the processor.

6. The video conference system of claim 4, wherein the display device is further configured to:
divide a displayed main screen into first, second and third divided screens,
display the first image of the first user group in the first divided screen,
display the second image of the second user group in the second divided screen, and
display information corresponding to the operation executed based on the command voice in the third divided screen.

7. The video conference system of claim 4, wherein the display device is further configured to:
further divide the main screen into a fourth divided screen, and
convert the conversation content into text and display the text in the fourth divided screen.

8. The video conference system of claim 3, wherein the processor is further configured to:
acquire the command voice via the transceiver,
apply information related to a situation in which the command voice is recognized to an artificial neural network (ANN) classifier,
receive an output of the ANN classifier,
analyze the intent of the command voice based on the output of the ANN classifier, and
execute the operation corresponding to the command voice based on the intent.

9. The video conference system of claim 8, wherein the ANN classifier is stored in an external artificial intelligence (AI) device, and
wherein the processor in the conference-assisting device is further configured to:
transmit feature values related to the information related to the situation in which the command voice is recognized to the external AI device, and
receive, from the external AI device, a result of applying the information related to the situation in which the command voice is recognized to the ANN classifier.

10. The video conference system of claim 8, wherein the ANN classifier is stored in a network, and
wherein the processor in the conference-assisting device is further configured to:
transmit the information related to the situation in which the command voice is recognized to the network, and
receive, from the network, a result of applying the information related to the situation in which the command voice is recognized to the ANN classifier.

11. The video conference system of claim 10, wherein the processor is further configured to:
receive, from the network, downlink control information (DCI) used to schedule transmission of the information related to the situation in which the command voice is recognized, and
wherein the information related to the situation in which the command voice is recognized is received from the network based on the DCI.

12. The video conference system of claim 11, wherein the processor is further configured to:
perform an initial access procedure with the network based on a synchronization signal block (SSB),
wherein the information related to the situation in which the command voice is recognized is transmitted to the network through a physical uplink shared channel (PUSCH), and
wherein a demodulation-reference signal (DM-RS) of the SSB and the PUSCH is quasi co-located (QCLed) for a QCL type D.

13. The video conference system of claim 11, wherein the processor is further configured to:
control the transceiver to transmit the information related to the situation in which the command voice is recognized to an artificial intelligence (AI) processor included in the network, and
control the transceiver to receive AI processed information from the AI processor, and
wherein the AI processed information is information obtained based on recognizing the command voice and analyzing the intent of the command voice.

14. A method for controlling a conference-assisting device using artificial intelligence, the method comprising:
learning conversation content of a conversation between a first user group and a second user group in a teleconference with the first user group;
in response to recognizing a preset wake voice in the conversation content during the teleconference, detecting a command voice following the wake voice;
analyzing, by an artificial intelligence (AI) processor, an intent of the command voice based on the conversation content and the command voice;
executing an operation corresponding to the command voice; and
displaying a first image of the first user group, a second image of the second user group, and a third image corresponding to the operation executed based on the command voice.

15. The method of claim 14, wherein the operation includes executing a function, executing an application program, or responding with audio output or visual output.

16. The method of claim 14, further comprising:
dividing a displayed main screen into first, second and third divided screens;
displaying the first image of the first user group in the first divided screen;
displaying the second image of the second user group in the second divided screen; and
displaying information corresponding to the operation executed based on the command voice in the third divided screen.

17. The method of claim 16, further comprising:
further dividing the main screen into a fourth divided screen; and
converting the conversation content into text and displaying the text in the fourth divided screen.

18. The method of claim 14, further comprising:
applying information related to a situation in which the command voice is recognized to an artificial neural network (ANN) classifier;
receiving an output of the ANN classifier;
analyzing the intent of the command voice based on the output of the ANN classifier; and
executing the operation corresponding to the command voice based on the intent.

19. A server device for providing an intelligent teleconference assisting service, the server device comprising:
a communication unit configured to communicate with a conference-assisting device; and
a controller configured to:
receive, from the conference-assisting device, conversation content of a conversation between a first user group and a second user group in a teleconference with the first user group,
receive, from the conference-assisting device, voice data of a speaker within the first user group or the second user group,
recognize a command voice uttered by the speaker during the teleconference,
analyze an intent of the speaker based on the conversation content and the command voice to generate an analysis result, and
transmit the analysis result to the conference-assisting device for executing an operation corresponding to the command voice of the speaker based on the intent.

20. The server device of claim 19, wherein the controller is further configured to:
apply information related to a situation in which the command voice is recognized to an artificial neural network (ANN) classifier,
receive an output of the ANN classifier, and
analyze the intent of the command voice based on the output of the ANN classifier to generate the analysis result.
